(19) United States
(12) Patent Application Publication
(10) Pub. No.: US 2025/0297528 A1
(43) Pub. Date: Sep. 25, 2025

(54) Method for Treating a Geological Formation

(71) Applicant: Swellfix UK Limited, Westhill, Aberdeenshire (GB)

(72) Inventors: Jonathan ABBOTT, Aberdeen (GB); Li JIANG, Katy, TX (US); Eilidh Jean MCKAY, Aberdeen (GB); Suzanne STEWART, Cypress, TX (US)

(73) Assignee: Swellfix UK Limited, Westhill, Aberdeenshire (GB)

(21) Appl. No.: 19/112,343

(22) PCT Filed: Jul. 5, 2024
(86) PCT No.: PCT/EP2024/069107

§ 371 Date: Mar. 17, 2025

(30) Foreign Application Priority Data
Jul. 7, 2023 (GB) 2310506.7
Jul. 7, 2023 (GB) 2310507.5
Jul. 7, 2023 (GB) 2310508.3

(51) Int. Cl. E21B 33/138; C09K 8/516

(52) U.S. Cl. CPC E21B 33/138; C09K 8/516; C09K 2208/08

(57) ABSTRACT

A method for creating a fluid barrier in a geological formation surrounding a wellbore includes delivering a plurality of swellable particulates into the wellbore and into a first zone of the formation, the plurality of swellable particulates configured to volumetrically swell to create a fluid barrier in response to exposure to a swelling activator. The method further includes exposing the plurality of swellable particulates to the swelling activator in the first zone of the formation to create the fluid barrier and establish a restriction against fluid migration through the first zone.

### FIELD

The present disclosure relates to a method for creating a fluid barrier in a geological formation surrounding a wellbore.

### BACKGROUND

Subterranean formations may require operations to be performed to improve the efficiency of extraction or injection processes performed on the formation. Operators may need to take into account a number of considerations when performing operations, especially when neighbouring zones in the formation contain unwanted fluids (such as, water, gas or supercritical fluid) that can undesirably migrate through the formation.

### SUMMARY

An aspect of the present disclosure relates to a method for creating a fluid barrier in a geological formation surrounding a wellbore, comprising:
delivering a plurality of swellable particulates into the wellbore and into a first zone of the geological formation, the plurality of swellable particulates configured to volumetrically swell to create a fluid barrier in response to exposure to a swelling activator; and
exposing the plurality of swellable particulates to the swelling activator in the first zone of the formation to create the fluid barrier and establish a restriction against fluid migration through the first zone.

The fluid barrier provided by the swellable particulates may function to prevent or delay unwanted fluid, such as water, gas or supercritical fluid, from flowing or migrating through the first zone. The first zone may be defined as a seal zone.

The formation may comprise a permeability capable of permitting fluid to migrate or flow through the formation. The formation may comprise a porosity. The formation may comprise one or more (e.g. tortuous) fluid paths. The method may comprise obstructing a fluid flow in the first zone with the swellable particulates. The fluid may be a liquid, gas or supercritical fluid. The fluid barrier may be defined as a hydraulic barrier.

The swellable particulates may be delivered into a first fracture in the first zone. Delivering the swellable particulates into the first zone of the formation may create the first fracture. Alternatively, the swellable particulates may be delivered into an existing fracture. The existing fracture may be a naturally existing fracture in the formation or a fracture created by a previous operation performed in the first zone.

The method may comprise performing an operation in a second zone of the geological formation. The second zone may be adjacent the first zone. The operation in the second zone may be performed before or after the swellable particulates have been delivered into the first zone. The method may comprise obstructing a fluid flow from the second zone with the swellable particulates in the first zone.

The operation performed in the second zone may comprise creating a second fracture in the second zone. The operation performed in the second zone may comprise a hydraulic fracturing operation. The method may comprise delivering a plurality of proppants into the second fracture in the second zone.

In addition to creating a fluid barrier, the swellable particulates may function to exert a compressive force on the formation as the swellable particulates volumetrically swell, creating a region of localised stress around the first zone. As such, the method may comprise exposing the swellable particulates to the swelling activator in the first zone of the formation to create a region of stress around the first zone. This stress concentration around the first zone may discourage the second fracture created in the second zone from extending towards the first zone.

The operation performed in the second zone may comprise extracting a formation product from the geological formation. The formation product may comprise a geothermal fluid. The formation product may comprise hydrocarbons (e.g. oil, gas and/or coal). The method may comprise flowing oil and/or gas from the geological formation into the wellbore via the second fracture for production at surface.

The operation performed in the second zone may involve injecting a gas or supercritical fluid into the formation, e.g. for storage.

The operation performed in the second zone may involve injecting a fluid or gas to improve hydrocarbon recovery, e.g. as part of an enhanced oil recovery (EOR) operation.

The operation performed in the second zone may comprise a drilling operation.

The operation performed in the second zone may comprise a mining operation, e.g. a coal mining operation.

The first zone may be a lower zone and the second zone may be an upper zone, or vice versa. Where the first zone is an upper zone (and thus located closer to surface than the second zone), the fluid barrier provided in the first zone may reduce or prevent fluids (such as, carbon dioxide) from migrating past the first zone and towards the surface.

In some examples, the first zone may be associated with a region of the geological formation that has been depleted and is producing unwanted fluids, such as water, gas or supercritical fluid. The second zone may be associated with a region of the geological formation containing a formation product (e.g. hydrocarbons or geothermal heat) to be extracted from the geological formation.

The first zone may be located around a first portion of the wellbore. The second zone may be located around a second portion of the wellbore, e.g. uphole or downhole of the first portion. Alternatively, the second zone may be located around a portion of a different wellbore, e.g. located adjacent the wellbore of the first zone.

The method may comprise delivering the swellable particulates into a third fracture in a third zone of the geological formation. The first zone may be located below the second zone and the third zone may be located above the second zone, or vice versa.

The method may comprise isolating the second zone with multiple fluid barriers or restrictions provided by the swellable particulates around the second zone. The method may comprise delivering the swellable particulates into multiple fractures in multiple zones of the geological formation surrounding the second zone. The method may comprise creating a fluid barrier around a perimeter of the second zone with swellable particulates.

The swellable particulates may be configured to swell between 10% and 400% of their completely unswelled size, for example between 10% and 200% of their completely unswelled size, for example between 10% and 100% of their completely unswelled size.

The swelling activator may be any suitable activator. The swelling activator may be or comprise a fluid. The swelling activator may be or comprise water. The swelling activator may be or comprise a water-based fluid. The swelling activator may be or comprise an oil.

The swellable particulates may comprise a swellable material configured to volumetrically swell in response to exposure to the swelling activator.

The swellable particulates may be configured to swell by osmosis. In this regard the swellable particulates may be defined as osmotic swellable particulates. The swellable particulates may comprise a material having a composition such that permeation of the swelling activator (e.g. water) into the swellable particulates will occur as a result of osmosis.

The swellable particulates may comprise a polymer. The swellable particulates may comprise a rubber.

The swellable particulates may comprise a material configured to provide a desired swell strength, longevity under downhole conditions, and/or chemical resistance. The swellable particulates may be configured to swell under formation conditions, such as formation pressures and temperatures.

The swellable particulates may comprise a granular material. The swellable particulates may comprise a non-degradable material. The swellable particulates may comprise a material configured to be unreactive to certain substances. The certain substances may include substances that the swellable particulates are expected to encounter during the operational lifetime of the swellable particulates. In other words, the swellable particulates may be configured to be substantially unaffected by exposure, i.e. not degrade when exposed, to the substances that the swellable particulates are expected to encounter during the operational lifetime of the swellable particulates.

The method may comprise transporting the swellable particulates downhole in a carrier fluid. The carrier fluid may be delivered into the wellbore at a pressure that exceeds a fracture pressure of the formation to create the first fracture in the first zone of the geological formation. The swellable particulates may be mixed with the carrier fluid for subsequent delivery into the wellbore in a premixed state. Alternatively, the swellable particulates may be injected or incorporated into the carrier fluid as the carrier fluid flows (e.g. is pumped) towards the wellbore.

The carrier fluid may be configured to limit or prevent swelling of the swellable particulates, e.g. as the swellable particulates are transported through the wellbore and into the geological formation. In particular, where the swellable particulates are water swellable particulates, the carrier fluid may comprise a saline solution, e.g., a high-salinity brine or other solvent. This may allow for swelling of the swellable particulates to be delayed until the swellable particulates are delivered into the first zone.

The rate of swelling may be modulated by manipulating an osmotic pressure differential across an interface between the swellable particulates and the carrier fluid, thus a rate of fluid penetrating into the swellable particulates can be controlled. This may allow for the rate at which the swellable particulates swell to be substantially reduced as the swellable particulates are transported through the wellbore and into the first zone.

The carrier fluid may be any suitable fluid. The carrier fluid may be a fluid used in a hydraulic fracturing process. The carrier fluid may comprise one or more additives. For example, the carrier fluid may comprise a viscosity agent, such as a thickener, to assist with suspending the swellable particulates and/or proppants in the carrier fluid. The carrier fluid may comprise one or more surfactants. The carrier fluid may be or comprise water. The carrier fluid may be or comprise a water-based fluid.

In some examples, the carrier fluid may comprise the swelling activator. In this regard the swellable particulates may partially swell as the carrier fluid transports the swellable particulates through the wellbore and into the first zone. The method may comprise retaining the carrier fluid in the first zone for a certain duration of time to achieve a desired amount of swelling. The method may comprise delivering an additional volume of the carrier fluid (when comprising the swelling activator) into the wellbore and into the first zone after the swellable particulates have been provided in the first zone to achieve a desired amount of swelling of the swellable particulates.

The swellable particulates may comprise a coating. The coating may be configured to degrade after a certain duration of time. The coating may be configured to degrade when exposed to a certain amount of a degrading agent. The degrading agent may be the same composition as the swelling activator. The coating may be configured to degrade at a predetermined point in a treatment process, e.g. in a hydraulic fracturing process. The coating may be configured to degrade when the swellable particulates have been provided in the first zone. This may prevent premature swelling of the swellable particulates (i.e. swelling to an undesirable extent) prior to reaching the first zone, which may otherwise inhibit the flow of the treatment fluid through the wellbore and into the first zone. The coating may comprise a material with a low molecular weight, such as a mineral oil. The coating may comprise a molecular weight in a range of 100 to 500 Da, preferably in a range of 125 to 400 Da and more preferably in a range of 150 to 300 Da. A material with a low molecular weight may form a temporary barrier between the swellable particulates and the swelling activator, and may eventually give way under shear and increasing temperatures.

The swellable particulates may be configured to swell at a certain swell rate, for example when exposed to the swelling activator. The swell rate of the swellable particulates may be configured to provide the swellable particulates in a swelled condition after a certain duration of time, or at a certain point in the method, e.g. when provided in the first zone. The swell rate of the swellable particulates may prevent premature swelling of the swellable particulates (i.e. swelling to an undesirable extent) prior to reaching the first zone.

The method may comprise utilising a swelling activator existing in the formation and exposing the swellable particulates to the swelling activator when delivered into the first zone.

The swellable particulates may be configured to remain in the swelled condition for a required time duration, such as a perceived operational lifetime of the swellable particulates. The operational lifetime of the swellable particulates may be based on one or more factors, such as the expected operational lifetime of the well (e.g. from production to abandonment), the expected operational lifetime of a reservoir associated with the well, or the expected operational lifetime of a neighbouring well, etc. In this regard the swellable particulates may be considered as a permanent installation.

The swellable particulates may be configured for effective transport through the wellbore and into the first zone. For example, the swellable particulates may comprise a grain size distribution between 5 and 500 mesh, more preferably between 10 and 100 mesh, when in an unswelled condition. However, the size of the swellable particulates may vary depending on the application.

The swellable particulates may be delivered into the wellbore by pumping the swellable particulates into the wellbore, e.g. suspended in the carrier fluid.

The swellable particulates may comprise one or more of a sphere, flake, cylinder, star, cube, etc. The swellable particulates may comprise the same size and shape, or different sizes and shapes.

The method may comprise delivering a plurality of fibre elements into the first zone. The swellable particulates may be combined with the fibre elements before delivering the swellable particulates into the wellbore. The fibre elements may be configured to be transported downhole in the carrier fluid.

The fibre elements may be configured to create a web arrangement for constraining movement of the swellable particulates in the first zone in response to exposure to an adhesion activator. The web arrangement created by the fibre elements may confine the swellable particulates in the first zone to prevent the swellable particulates from moving to a more dispersed, relaxed position during and after the swelling process, thereby enhancing the fluid barrier created by the swellable particulates.

The web arrangement created by the fibre elements may comprise any shape or structure capable of constraining movement of the swellable particulates in the first zone. The web arrangement created by the fibre elements may comprise an interconnected network of fibre elements in the first zone. The web arrangement created by the fibre elements may comprise one or more groups or clusters of fibre elements in the first zone.

The size of the clusters may be controlled by adjusting a ratio (e.g. a stoichiometric ratio) of the swellable particulates to fibre elements.

The swelling activator and adhesion activator may comprise the same activator or different activators. Where the swelling activator and adhesion activator comprise different activators, this may allow for independent control of creation of the web arrangement and swelling of the swellable particulates.

The adhesion activator may be any suitable activator. The adhesion activator may be defined by a condition change, such as a change in temperature or pressure. The adhesion activator may comprise a fluid or chemical. In a preferred example, however, the adhesion activator is or is defined by an activation temperature.

A concentration or weight of the fibre elements may be based on a concentration or weight of the swellable particulates. For example, a weight of the fibre elements may be in a range from 0.5% to 10% of the total weight of swellable particulates.

The fibre elements may be configured to comprise or exhibit one or more characteristics. The one or more characteristics of the fibre elements may be temperature or chemically activated. The fibre elements may be configured to comprise or exhibit a selectively adhesive characteristic, e.g. a selectively tacky characteristic. The fibre elements may be configured not to adhere to one another and/or the swellable particulates until the fibre elements have been temperature or chemically activated. In one preferred example, the adhesive characteristic of the fibre elements is temperature activated at a temperature in a range between 60 to 200 degrees Celsius. The fibre elements may comprise or be similar to fibre elements described in WO 2010/075248 A1, which is incorporated herein by reference.

Alternatively or additionally, the swellable particulates may be configured to adhere to one another and/or the fibre elements after absorbing the swelling activator. The swellable particulates may be configured to exhibit or comprise an adhesive characteristic (e.g. a tacky characteristic) after absorbing the swelling activator. Where the swellable particulates comprise water swellable particulates, and have absorbed the swelling activator (i.e. water), the swellable particulates may be configured to adhere to one another by virtue of a hydrogen bond (H-bond) between adjacent swellable particulates. In this respect a hydrogen bond (H-bond) network may be formed by the swellable particulates. The swellable particulates may be configured to form clusters with one another after absorbing the swelling activator.

The fibre elements may be configured to withstand exposure to certain substances that the fibre elements may encounter during their operational lifetime, including expected downhole pressures, temperatures, reservoir fluids and chemicals used during typical stimulation operations.

The fibre elements may be configured to degrade upon exposure to a degrading agent. The degrading agent may comprise one or more additives or chemicals. This may provide for the web arrangement created by the fibre elements to be reversed upon delivery of the degrading agent to the fibre elements in the first zone.

The fibre elements may be configured to be substantially non-swellable, i.e. completely non-swellable or swellable to a negligible extent.

The fibre elements may comprise various sizes. The fibre elements may comprise a variety of cross-sectional shapes, e.g. circular, prismatic, cylindrical, lobed, rectangular or polygonal. The fibre elements may comprise a straight profile or an undulating profile.

The fibre elements may be configured to provide a large surface area relative to a volume of the fibre elements. The fibre elements may comprise an aspect ratio of at least 2:1, for example 10:1, 100:1, 1000:1, etc. Larger aspect ratios (e.g., having aspect ratios of 10:1 or more) may help promote the formation of a network of the fibre elements, as well as allowing for more swellable particulates to adhere to external surfaces of the fibre elements.

The fibre elements may have a length in a range of 2 to 60 mm. The fibre elements may comprise a cross-sectional dimension of up to 500 micrometres.

The fibre elements may comprise one or more additives and/or coatings, for example to impart desirable properties such as handling, processability, stability and dispersibility.

The fibres elements may comprise one or more surfactants, e.g. emulsifiers. The surfactants may be configured to improve the dispersibility or handling of the fibre elements. In some examples, the surfactants may be added to the fibre elements in a range of 0.05 to 3 percent by weight of the fibre elements.

The fibres elements may comprise one or more polymeric dispersing agents. The polymeric dispersing agents may be configured to promote the dispersion of the fibre elements in a chosen medium and at desired application conditions (e.g., extreme pH and/or elevated temperatures). In some examples, the polymeric dispersing agents may be added to the fibre elements in a range of 0.05 to 5 percent by weight of the fibre elements.

The fibres elements may comprise one or more antioxidants. The antioxidants may be configured to retain useful properties of the fibre elements through their operational life. In some examples, the antioxidants may be added to the fibre elements in a range of 0.05 to 1.5 percent by weight of the fibre elements.

The fibres elements may comprise one or more of colorants (e.g. dyes and pigments), fillers (e.g. carbon black, clays, and silica) and surface applied materials (e.g. waxes, talcs, erucamide, gums, and flow control agents), for example to help improve storage, transportation and handling.

The fibre elements may comprise a core-shell configuration.

The core may be configured to provide rigidity. The shell may be configured to comprise or exhibit the adhesive characteristic of the fibre elements referred to hereinabove.

The shell may comprise a polymeric material or a blend of polymeric materials. The shell may comprise one or more other additives, e.g. a plasticizer, a superabsorbent polymeric material, etc. The shell may comprise at least one of a thermoplastic composition and a curable resin. The shell may comprise or be formed of an ethylene acid copolymer, which may be partially neutralized. In some examples, the shell may comprise or be formed of a product sold under the trade name SURLYN™ Ionomers sold by DOW, such as SURLYN™ 1605 Ionomers or SURLYN™ 1702 Ionomers.

The shell may comprise a softening point. A softening temperature of the shell may be configured to be slightly greater than an anticipated temperature of the reservoir zone to be treated. The desired softening temperature can be achieved by selecting an appropriate single polymeric material or combining two or more polymeric materials. Exemplary polymeric materials may have or may be modified to have a softening temperature in the range of 60 to 150 degrees Celsius.

The fibre elements may be configured to bond without significant loss of their core-shell configuration or shape. The fibre elements may be configured to maintain a spatial relationship of the core and shell after the adhesive characteristic of the fibre elements has been activated.

In some examples, the shell may comprise an elastic modulus of less than 3×10⁵ N/m² at a frequency of about 1 Hz at a temperature of at least 60 degrees Celsius.

The core may comprise blends of polymers and/or other components. The core may have a melting point at a temperature in a range of 130 and 220 degrees Celsius. The core may comprise at least one of a thermoplastic composition and a curable resin. In some examples, the core may comprise or be formed of a nylon, such as Nylon66.

The fibre elements may be formed using techniques known in the art for making core-shell fibres, such as fibre spinning. The fibre elements may be crosslinked, for example through radiation or chemical means.

The method may comprise setting a first plug or diverter at a first location in the wellbore to direct the plurality of swellable particulates into the first zone. The method may comprise subsequently setting a second plug or diverter at a second location in the wellbore to direct the proppants into the second zone.

The method may comprise delivering a filler material into the first zone. The filler material may be or comprise sand (for example, a fine mesh sand), glass, etc. The swellable particulates may be combined with the filler material before delivering the swellable particulates into the wellbore. The filler material may be configured to be transported downhole in the carrier fluid. The filler material may reduce the mass of swellable particulates required to perform a particular treatment process. The swellable particulates may be configured to swell against or around the filler material. At least one of the filler material and swellable particulates may be configured to be at least partially deformable, e.g. when engaged with one another.

The method may comprise flowing or displacing the carrier fluid from the first zone, e.g. back into the wellbore. For instance, the carrier fluid may flow or be displaced by reducing a pressure of the carrier fluid, e.g. from surface. Alternatively, or in addition, a natural pressure of the formation may act on the carrier fluid to force the carrier fluid out of the first zone.

The method may comprise chasing or over-flushing the carrier fluid using a chaser fluid, e.g. which may be delivered into the wellbore after the swellable particulates have been delivered into the wellbore. This may force the carrier fluid to be displaced from the first zone further into the formation, which may help accelerate in-situ swelling of the swellable particulates in the first zone. The chaser fluid may comprise the swelling activator.

The method may comprise retaining the swellable particulates in the first zone while flowing or displacing the carrier fluid from first zone. The method may comprise engaging the swellable particulates with a wall of the first fracture in the first zone. In this regard friction between the swellable particulates and the fracture wall may prevent the swellable particulates from flowing out of the first fracture as the carrier fluid flows out of the first fracture.

The method may comprise forming a bridge with at least a portion of swellable particulates at a fracture tip of the first fracture. Bridging is a phenomenon which occurs where particulates of a certain size simultaneously arrive at a constriction in a flow path and form a bridge or arch across the constriction, thereby obstructing the flow path and preventing further particulates from travelling past the constriction. Bridging is dependent on parameters including the size ratio between the particulates and the constriction, the concentration of particles, the carrier fluid viscosity, the presence of other solid additives and a flow velocity of the particulates. The method may comprise delivering the swellable particulates into the first fracture and bridging the swellable particulates at the fracture tip to enable the swellable particulates to be provided throughout the first fracture.

The first fracture may vary in cross-sectional area along a length of the first fracture. The facture tip may have a smaller cross-sectional area than a main section of the first fracture. The swellable particulates may be configured to bridge with one another at the fracture tip, for example at a distance from an outermost point of the fracture. As such, the method may comprise providing the swellable particulates with a certain size based on at least one of formation pore dimensions and expected fracture dimensions (which, for example, may be obtained by performing hydraulic fracturing simulations). The swellable particulates may comprise a certain shape, size and/or size distribution so that the swellable particulates bridge with one another at the fracture tip. The method may comprise delivering the swellable particulates into the fracture at a certain flowrate in a carrier fluid optimised to encourage bridging of the swellable particulates at the fracture tip.

The method may comprise monitoring parameters of the swellable particulates, for example a pressure and flowrate of the swellable particulates. The method may comprise monitoring for a parameter change and associating the change with the creation of a fracture in the formation. For example, the parameter change may comprise a pressure drop or an increase in flowrate of the swellable particulates.

In some examples, creating the second fracture in the second zone may comprise delivering a second plurality of swellable particulates into the wellbore and into the second fracture in the second zone, and subsequently delivering the plurality of proppants into the wellbore and into the second fracture. The swellable particulates may be delivered ahead of the proppants such that the swellable particulates are provided towards a fracture tip of the second fracture, and the proppants are provided in a main section of the second fracture behind the swellable particulates.

An aspect of the present disclosure relates to a method for creating a region of stress in a geological formation, comprising:
delivering a plurality of swellable particulates into the wellbore and into a first zone of the geological formation, the plurality of swellable particulates configured to volumetrically swell in response to exposure to a swelling activator; and
exposing the plurality of swellable particulates to the swelling activator in the first zone of the formation such that the swellable particulates exert a force on the formation as the swellable particulates volumetrically swell creating a region of stress in the first zone.

It will be appreciated that features described in relation to one aspect may be equally combined with any other aspect described herein.

### BRIEF DESCRIPTION OF THE DRAWINGS

These and other aspects of the present disclosure will now be described, by way of example only, with reference to the accompanying drawings, in which:

FIGS. 1 and 2 are schematic illustrations of a method for treating a geological formation;

FIGS. 3 and 4 are schematic illustrations of a method for treating a geological formation;

FIG. 5 is a schematic illustration of a fracture comprising swellable particulates;

FIG. 6 is a schematic illustration of a fracture tip comprising swellable particulates and fibre elements; and

FIGS. 7 and 8 are images taken from a laboratory test performed by the present inventors demonstrating plugging effects with and without fibre elements; and

FIG. 9 is a summary chart of the laboratory tests.

### DETAILED DESCRIPTION OF THE DRAWINGS

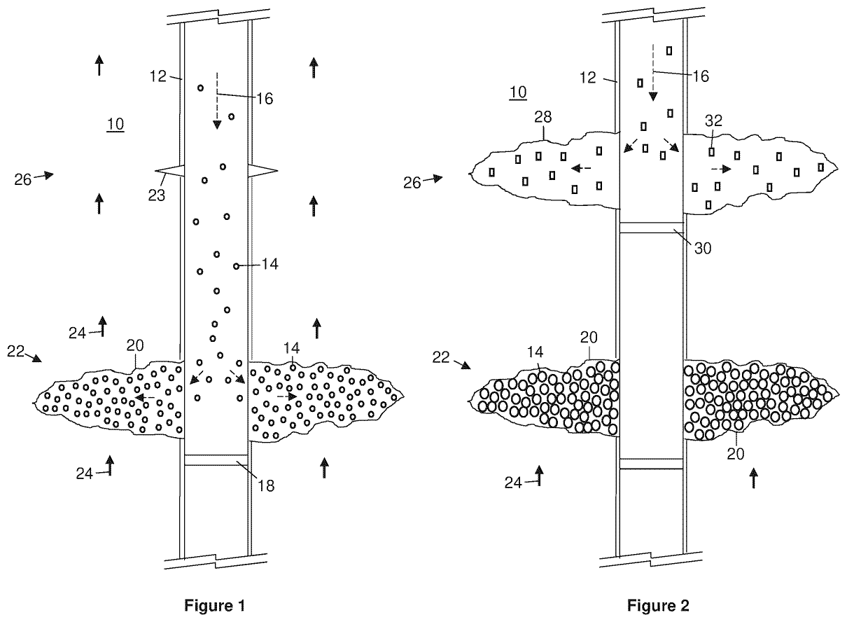

FIGS. 1 and 2 provide a schematic illustration of a method for creating a fluid barrier in a geological formation 10 surrounding a wellbore 12. Multiple applications may benefit from the creation of a fluid barrier in the geological formation 10 for various purposes. However, for the purposes of providing an exemplary application, the following description generally relates to creating a fluid barrier in the geological formation 10 to restrict fluid migration associated with a hydraulic fracturing process.

FIG. 1 schematically illustrates a plurality of swellable particulates 14 being transported (e.g. pumped) through a wellbore 12 in a carrier fluid in a downhole direction 16. A first plug or diverter 16 is set in the wellbore 12 to direct the plurality of swellable particulates 14 into a first fracture 20 in a first zone 22 of the formation 10. In some examples, the carrier fluid may be delivered into the geological formation 10 at a pressure that exceeds a fracture pressure of the formation 10 to create the first fracture 20. Alternatively, the swellable particulates 14 may be delivered into an existing fracture 20 in the formation 10, for example a naturally existing fracture in the formation or a fracture created by a previous operation performed in the first zone 22.

Referring to FIG. 2, after being exposed to a certain amount of a swelling activator, the swellable particulates 14 have volumetrically swelled to create a fluid barrier in the first fracture 20, thus establishing a fluid restriction in the first zone 22 that obstructs a fluid migration or flow 24. The first zone 22 may be associated with a region of the formation 10 that has been depleted and is producing unwanted fluids, such as water, gas or supercritical fluid. The fluid barrier provided by the swellable particulates 14 may therefore function to prevent or delay such unwanted fluids from migrating through the first zone 22 and into a second zone 26 of the formation 10.

The second zone 26 may be associated with a region of the geological formation 10 containing a formation product (e.g. hydrocarbons or geothermal heat) for extraction. In the illustrated example, a hydraulic fracturing operation has been performed in the second zone 26 creating a second fracture 28 in the formation 10 through a perforation 23 in the wellbore 12. In this example, the first zone 22 is a lower zone and the second zone 26 is an upper zone; however, in other examples, the first zone 22 may alternatively be an upper zone and the second zone 26 may be a lower zone.

A second plug or diverter 30 has been set at a second location in the wellbore 12 to direct a plurality of proppants 32 into the second fracture 28 in the second zone 26, to increase the permeability of the formation 10 for producing the formation 10 product at surface. In addition to creating a fluid barrier, the swellable particulates 14 exert a compressive force on the formation 10 as the swellable particulates 14 volumetrically swell, creating a region of stress around the first zone 22 discouraging the second fracture 28 from extending towards the first zone 22.

The hydraulic fracturing operation may be performed after the swellable particulates 14 have been delivered into the first fracture 20. In other examples, the hydraulic fracturing operation may be performed before the swellable particulates 14 have been delivered into the first zone 22, for example to pre-empt a fluid flow induced by the hydraulic fracturing process in the second zone 26. However, as noted above, multiple other applications may benefit from the creation of such a fluid barrier in the geological formation 10. For example, other operations performed in the second zone 26 may include a drilling or mining operation.

The swellable particulates 14 may comprise a material configured to provide a desired swell strength, longevity under downhole conditions, and/or chemical resistance. The swellable particulates 14 may be configured to retain the swelling activator, once absorbed, to remain in the swelled condition for a perceived operational lifetime of the swellable particulates 14. The perceived operational lifetime may be based on an operational lifetime of the well (e.g. from production to abandonment), the expected operational lifetime of a reservoir associated with the well, or the expected operational lifetime of a neighbouring well (such as, an infill well), etc. The swellable particulates 14 may be non-degradable in the sense that they may be configured to withstand exposure to certain substances that the swellable particulates 14 may encounter during their operational lifetime. In this regard the swellable particulates 14 may be considered as permanent. In some examples, a density of the swellable particulates 14 may be modified to promote settling of the swellable particulates 14 at a low or high side of the first fracture 20.

The carrier fluid may be any suitable fluid. In some examples, the carrier fluid is a water-based fluid, such as may be used in a hydraulic fracturing process. The carrier fluid may comprise the swelling activator causing the swellable particulates 14 to partially swell as the swellable particulates 14 are transported through the wellbore 12. To prevent premature swelling of the swellable particulates 14, the swellable particulates 14 may comprise a coating configured to degrade at a predetermined stage in the process, e.g. after being delivered into the first zone 22. Alternatively, or in addition, the swellable particulates 14 may be configured to swell at a certain swell rate when exposed to the swelling activator to prevent the swellable particulates 14 from swelling to an undesirable extent prior to reaching the first zone 22. In other examples, the carrier fluid may not comprise the swelling activator. Instead, the swelling activator may be delivered into the wellbore 12 sometime after the swellable particulates 14 have been delivered into the wellbore 12. For example, the swelling activator may be delivered into the wellbore 12 as part of a flush stage in a hydraulic fracturing treatment. Alternatively, the method may comprise utilising a swelling activator present in the formation 10 and exposing the swellable particulates 14 to the swelling activator in the first zone 22.

The first fracture 20 may vary in cross-sectional area along a length of the first fracture 20, with the first facture tip having a smaller area than a main section of the first fracture 20. The swellable particulates 14 may be configured to bridge with one another in the first fracture 20 towards the fracture tip such that the swellable particulates 14 are provided throughout the first fracture 20. Additionally, the swellable particulates 14 may comprise a granular form having a grain size distribution between 10 and 200 mesh, which may in addition help effectively transport the swellable particulates 14 through the wellbore 12 and into the first fracture 20.

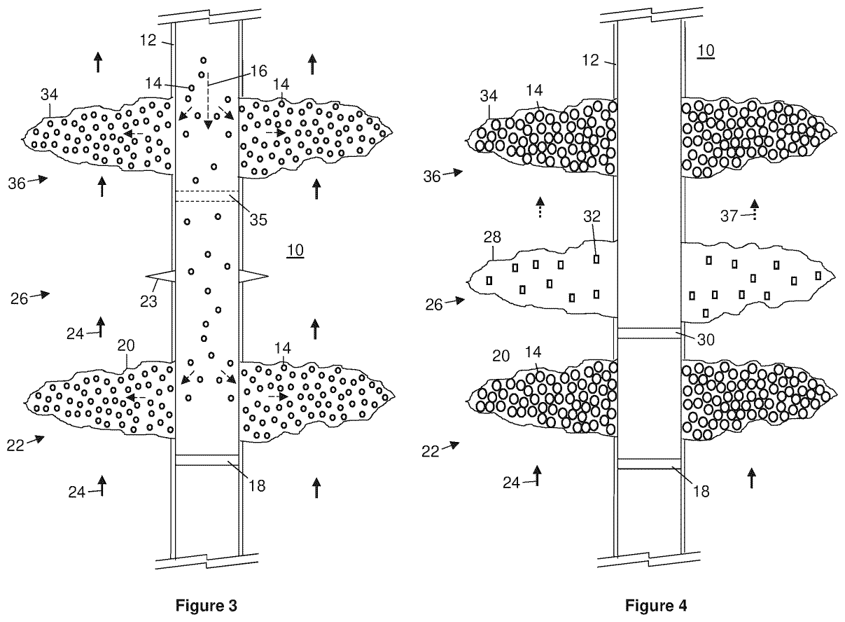

Referring to FIGS. 3 and 4, the method may comprise setting a third plug or diverter 35 in the wellbore 12 and delivering the swellable particulates 14 into a third fracture 34 in a third zone 36 of the geological formation 10. The carrier fluid may be delivered into the wellbore 12 at a pressure that exceeds a fracture pressure of the formation 10 to create the third fracture 34. Alternatively, the swellable particulates 14 may be delivered into an existing fracture 34 in the third zone 36.

The first zone 22 may be located below the second zone 26 and the third zone 36 may be located above the second zone 26, thereby isolating the second zone 26 with a fluid barrier above and below the second zone 26. The fluid barrier provided in the third zone 36 may reduce or prevent a fluid 37 (such as, carbon dioxide) from the second zone 26 migrating through the third zone 36 and towards the surface. In some examples, the method may comprise delivering the swellable particulates 14 into multiple other fractures in multiple zones of the geological formation 10 to isolate the second zone 26 on multiple sides.

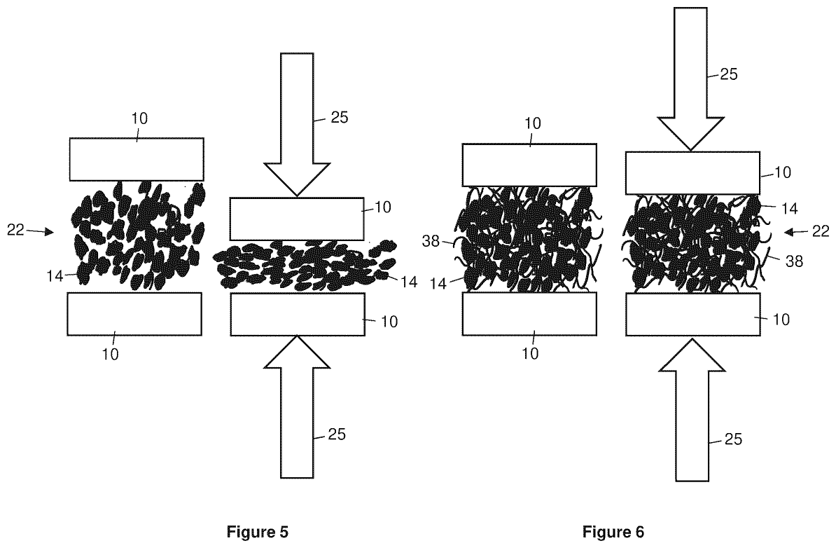

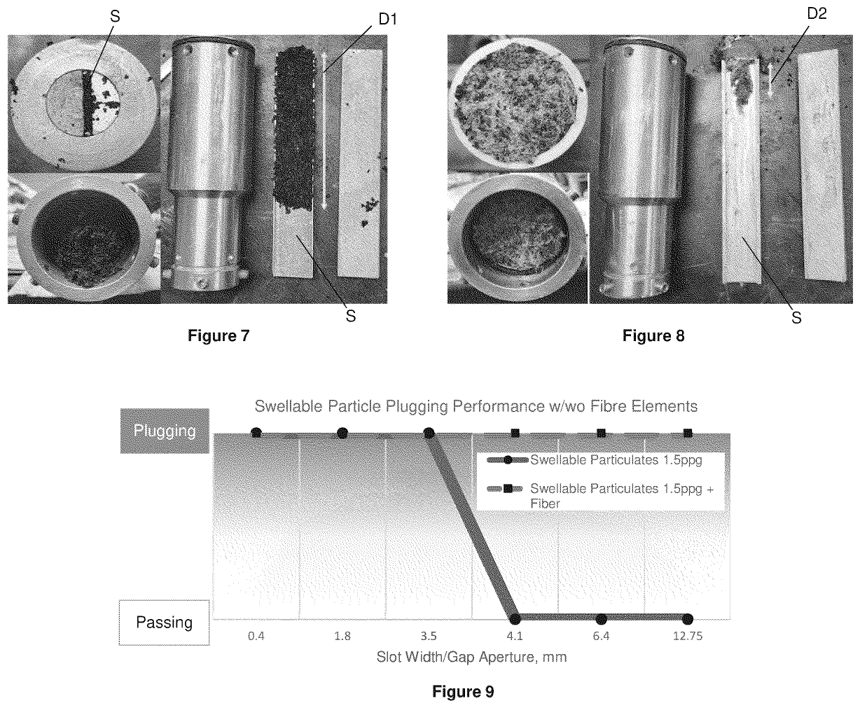

Referring to FIGS. 5 and 6, the swellable particulates 14 may be combined with fibre elements 38 before delivering the swellable particulates 14 into the wellbore 12. The fibre elements 38 may be configured to comprise or exhibit a selectively adhesive characteristic, which may be temperature or chemically activated. Once activated, the fibre elements 38 may create a web arrangement with one another in the first fracture 20 for constraining movement of the swellable particulates, which may prevent the swellable particulates 14 from moving to a more dispersed, relaxed position during and after the swelling process. This may help maximize the fluid barrier created and the resulting stress concentration in the formation 10. As schematically illustrated in FIG. 7, once the carrier fluid has been displaced from the first fracture 20 and the formation 10 acts on the swellable particulates 14 with a compressive force in the direction of arrows 25, the fibre elements 38 may help maintain the swellable particulates 14 in place in the first fracture 20.

The present inventors performed laboratory testing in which a TWC-06 rubber sample (representing a mass of swellable particulates 14) was placed into a metal housing and allowed to swell in fresh water for 6 days at 110° C. The rubber sample achieved 89% swelling of its initial unswelled volume after the 6 days elapsed. Pressure was then applied to the rubber sample while in the metal housing using a 20 tonne load cell to record the load applied. The amount of compression of the rubber sample was measured at 20% from its swelled volume (89% of its unswelled volume) and a maximum pressure of around 23 MPa (3300 psi) was recorded. Applying these results in context, a typical virgin stress for a 2400 m (8000 ft.) well with normal faulting may be in the order of 33 MPa (4800 psi). Thus, the laboratory testing suggests that the stress produced by further compression of the swellable particulates 14 inside the first fracture 20 could be at least comparable to the initial in-situ stress and may exceed this over time during pore pressure depletion.

In addition, the present inventors performed laboratory testing demonstrating the plugging effects obtainable with and without fibre elements. In particular, a slotted test apparatus was provided and a piston cylinder was used to deliver a slurry mixture of water and swellable particulates (and, depending on the test performed, fibre elements) into a slot of the test apparatus. The piston cylinder included a sample chamber for receiving the slurry mixture and a pressure chamber for receiving pressurised gas to drive a piston to displace the slurry mixture from the sample chamber and into the slotted test apparatus. A valve was provided for opening and closing a flow path from the slotted test apparatus.

The test method comprised mixing one litre of water with 60 grams of swellable particulates (i.e., 0.5-1.5 lbs per gallon (0.06-0.18 g/ml) equivalent concentration) to provide a slurry mixture. The slurry mixture was delivered into the sample chamber and a pressure inside the pressure chamber was increased up to a pressure threshold of 50 psi (345 kPa). The valve was then opened and the slurry displaced through the slot of the slotted test apparatus was recorded every 15 seconds until the sample chamber had emptied. If the sample chamber had not emptied at 50 psi (345 kPa), the pressure inside the piston chamber was then increased in 50 psi (345 kPa) increments up to 200 psi (1.38 MPa), and the pressure at which plugging integrity was lost was recorded. The present inventors repeated the above tests for a slurry mixture also comprising temperature-activated fibre elements. FIGS. 7 and 8 are images taken from the slotted test apparatus after the tests described above had been performed, with and without fibre elements, respectively.

The size distribution for the coarse size of the swellable particulates used in the laboratory testing is provided in Table 1 below.

TABLE 1

| Microns | wt (g) | diff % | cum % |
|---|---|---|---|
| 710 | 17.6 | 88.9 | 88.9 |
| 500 | 0.4 | 1.9 | 90.8 |
| 355 | 0.3 | 1.5 | 92.3 |
| 250 | 0.3 | 1.4 | 93.7 |
| 180 | 0.29 | 1.5 | 95.2 |
| 150 | 0.13 | 0.7 | 95.9 |
| 90 | 0.33 | 1.7 | 97.5 |
| 70 | 0.09 | 0.5 | 98 |
| pan | 0.4 | 2 | 100 |

FIG. 7 shows the results of the test performed without fibre elements. The slotted test apparatus was set up to provide the slot S with a width of 4 mm. A slurry mixture with a concentration of 1.5 ppg (0.18 g/ml) of swellable particulates was used. As shown by the distance D1, which illustrates the length through the slot which the swellable particulates travelled before bridging, the amount of material lost through the slotted test apparatus is substantial. In practical terms, this would mean a large volume of material is required to provide a plug and seal across a fracture having similar dimensions. FIG. 8 shows the results of the test performed with the same 1.5 ppg (0.18 g/ml) mixture of swellable particulates but with the addition of the temperature-activated fibre elements. The fibre elements were added to the slurry mixture in a concentration of 3% by weight of swellable particulates. As illustrated by the distance D2, under the same slot testing conditions, a plug is formed very early on bridging the slot and limiting the loss of material. Therefore, the laboratory tests demonstrate that the fibre elements provide for improved consolidation of the slurry.

In practical terms, these results show that the addition of the fibre elements can improve bridging and reduce the amount of material required to create a robust plug and seal. A summary chart of the plugging results with and without fibre elements for different slot widths is illustrated in FIG. 9, which shows that the plugging potential of a given swellable particulate distribution can be extended with the addition of temperature-activated fibre elements. In particular, FIG. 9 illustrates the slot width at which seal integrity was lost when tested at pressures of 200 psi (1.38 MPa). As can be seen, for slurry mixtures not comprising fibre elements, the seal integrity was lost at a slot width of 4.1 mm, only slightly above the 4 mm test described above. The slurry mixture comprising fibre elements, however, was able to maintain seal integrity up to a maximum slot width of the apparatus, 12.75 mm.

It is intended that the fibre elements bond to each other creating a web which promotes plugging of swellable particulates in higher slot widths. This enables the swellable particulates to seal larger loss zones. As such, the web formed by the fibre elements may substantially help improve the plugging performance under downhole conditions. As described hereinabove, in some examples, the fibre elements may not be activated at surface temperatures and conditions and therefore can be easily prepared and pumped using standard surface equipment and passing through pipework and completion restrictions. This same approach can be applied to a range of particle size distributions to enhance the bridging tendency and plugging potential in larger slots and in field applications for induced/natural fractures, vugs and intervals with substantial losses.

1. A method for creating a fluid barrier in a geological formation surrounding a wellbore, comprising:
delivering a plurality of swellable particulates into the wellbore and into a first zone of the formation, the plurality of swellable particulates configured to volumetrically swell to create a fluid barrier in response to exposure to a swelling activator; and
exposing the plurality of swellable particulates to the swelling activator in the first zone of the formation to create the fluid barrier and establish a restriction against fluid migration through the first zone.

2. The method of claim 1, comprising delivering the swellable particulates into a first fracture in the first zone.

3. The method of claim 2, wherein delivering the swellable particulates into the first zone of the formation creates the first fracture.

4. The method of claim 1, comprising performing an operation in a second zone of the geological formation.

5. The method of claim 4, wherein the operation comprises creating a second fracture in the second zone.

6. The method of claim 4, wherein the operation comprises extracting a formation product from the second zone.

7. The method of claim 4, comprising obstructing a fluid flow within the formation from the second zone with the swellable particulates in the first zone.

8. The method of claim 4, wherein the first zone is an upper zone and the method comprises creating the fluid barrier to establish a restriction against fluid migration from the second zone towards the surface.

9. The method of claim 1, comprising exposing the swellable particulates to the swelling activator in the first zone to create a region of stress around the first zone of the formation.

10. The method of claim 1, wherein the swellable particulates are non-degradable.

11. The method of claim 1, wherein the swellable particulates are configured to be substantially unaffected by substances the swellable particulates are expected to encounter during their operational lifetime.

12. The method of claim 1, wherein the swellable particulates comprise a coating configured to degrade after a certain duration of time.

13. The method of claim 1, wherein the swellable particulates are configured to swell at a certain swell rate in response to exposure to the swelling activator to provide the swellable particulates in a swelled condition after a certain duration of time.

14. The method of claim 1, comprising delivering a plurality of fibre elements into the wellbore and into the first zone, the fibre elements configured to adhere to one another to create a web arrangement for constraining movement of the swellable particulates in response to exposure to an adhesion activator.

15. The method of claim 14, comprising mixing the swellable particulates with the fibre elements for subsequent delivery into the wellbore in a premixed state.

16. The method of claim 14, wherein the swelling activator and adhesion activator are different activators.

17. The method of claim 1, wherein the swelling activator is at least one of water, oil and supercritical fluid.

18. The method of claim 14, wherein the adhesion activator is defined by an activation temperature.

19. The method of claim 14, wherein the fibre elements comprise a core-shell configuration.

20. The method of claim 1, wherein the swellable particulates are configured to comprise or exhibit an adhesive characteristic after absorbing the swelling activator.

21. The method of claim 1, comprising transporting the swellable particulates through the wellbore and into the first zone with a carrier fluid.

22. The method of claim 1, wherein the carrier fluid comprises the swelling activator.

23. The method of claim 14, comprising exposing the swellable particulates to the swelling activator only after the swellable particulates have been delivered into the first zone of the formation.

24. The method of claim 1, wherein the swellable particulates comprise a grain size distribution between 5 and 500 mesh.

25. The method of claim 1, wherein delivering the swellable particulates into the wellbore comprises pumping the swellable particulates into the wellbore.
